(19) United States
(12) Patent Application Publication
(10) Pub. No.: US 2005/0075817 A1
(43) Pub. Date: Apr. 7, 2005

(54) Functional test apparatus for a field device, a method for functional testing of a field device, and a field device

(76) Inventors: Harald Kah, Brechen (DE); Thomas Karte, Bruchkobel (DE); Jorg Kiesbauer, Eppertshausen (DE); Peter Opl, Dietzenbach (DE); Karl-Bernd Schartner, Erlensee (DE)

Correspondence Address: SCHIFF HARDIN, LLP;PATENT DEPARTMENT, 6600 SEARS TOWER, CHICAGO, IL, 60606-6473, US

(21) Appl. No.: 10/948,819

(22) Filed: Sep. 23, 2004

(30) Foreign Application Priority Data
Sep. 23, 2003 (DE) 103 44 088.7-52

(51) Int. Cl. G06F 19/00

(52) U.S. Cl. 702/108

(57) ABSTRACT

A functional test apparatus for a field device, particularly for a quick-acting gate valve for an emergency system, preferably of a chemical installation, of a gas burner or the like, with the field device configured to change or to be changed to a specific operating mode, particularly a safety or emergency operating mode, in case there is no power supply, comprises at least one device for detection of operating data for the field device, and at least one non-volatile memory for saving the detected operating data, at least one electrical energy buffer is provided which acts on the device for detention of operating data and on the non-volatile memory for supplying them with power, such that the operating data of the field device is detected and is saved in a non-volatile manner at least while the field device is making a transition to the specific operating mode.

### BACKGROUND

The present invention relates to a functional test apparatus for a field device, wherein the functional test apparatus and the field device can be supplied with electrical power, and the field device can be changed to a specific operating mode when there is no power supply. The functional test apparatus comprises at least one device for detection of operating data of the field device, and at least one non-volatile memory for recording the detected operating data.

The invention also relates to a method for functional testing of a field device which responds in particular in accordance with the method of operation of a functional test apparatus according to the invention, and to a field device.

The monitoring of safety-relevant measurement and control circuits is playing an ever more important role in the process industry. Particularly with regard to the design of emergency switching systems, it is of critical importance to be able to make statements about the reliability of correct operation in an emergency situation, or about the failure probability of field devices.

When using field devices which are connected to one another or to a process control device via two-wire technology, observation (which is desirable for monitoring of the field device) and storage of operating data for it have, however, previously not been possible in all cases. For example, in the case of a two-wire line which ensures not only the power supply but also signal transmission via a single line, particularly during the critical time of switching off or interrupting the power supply or the time period immediately before this, the analog or also the digital signal transmission is disturbed and collapses completely in the event of a safety disconnection as a result of the electrical power supply being disconnected. For example, in the case of valve control, electrical position controllers force movement to the so-called fail-safe position or safety position by disconnection of the common electrical supply line and signal line. However, this disconnection effects that it is not possible for a central process control device to observe the valve movement until it reaches the final position or safety position.

Furthermore, in the case of functional monitoring apparatuses of this generic type, which store operating data for the field device internally, pick-up of operating data before and during a safety operating mode in which the field device is switched to a safety state, for example, with a valve being moved to the safety position, is not possible without further problems. For example, non-volatile memories within the functional test apparatus are used for storage of operating data via the two-wire loop during normal operation, i.e., when the power supply is intact. This data which is stored in the non-volatile memory can then be called up and evaluated after safety operation. However, these non-volatile memories can be written to only a limited number of times, i.e., approximately 100,000 to 1,000,000 write cycles. It is thus necessary for data first of all to be gathered over a relatively long time interval before being stored in the non-volatile memory.

In order to ensure that the field device can be operated without maintenance over several years, it is thus necessary to gather the data in a volatile memory in the functional test apparatus over a time period of 0.5 to 6 hours before it is stored in the non-volatile memory. This means that, in the event of a safety disconnection as a result of disconnection of the power supply to the field appliance via the two wire loop, the operating data is lost for a period of up to 0.5 to 6 hours, during which it has been stored in the volatile memory before the safety disconnection, and has not been transferred to the non-volatile memory. Furthermore, relatively extensive cyclic storage of relevant data from continuous operation is possible only to a restricted extent owing to the small amount of power that is available (e.g., 20 to 40 mW) and the volatile memory size which is thus limited.

In order, nevertheless, to allow statements to be made about the serviceability of the field device in a safety operating mode, it is known from the prior art for field devices such as these to impose minor control signals in a normal operating mode in order to carry out a regular check of various variables, such as a response time or a movement time, and thus to determine variables such as inertia and the like.

However, in particular, these measures do not allow parameters such as the safety disconnection response time, i.e., the time between application of the signal for safety disconnection and first movement of the valve, the closing time, i.e., the time for the valve to move from an open position to a closed position, or the accuracy with which the zero point position or safety position is reached, to be determined directly.

Particularly in the process industry, safety-relevant measurement and control circuits are, however, being increasingly classified in accordance with IEC 61508/61511. This means that field devices are required to carry out both qualitative and quantitative observation and documentation of the behavior of the field device, not only during the normal operating mode but also in a safety operating mode when the power supply has been disconnected.

In addition, observation and recording of important operating and status information is valuable for the operator even for measurement and control circuits which are not safety-relevant. Data can then be obtained directly from these observations in order to determine the MTBF (Mean Time Between Failures) and to carry out FMEDA (Failure Mode, Effects and Diagnostic Analysis). These variables are used to classify the safety-relevant circuits, and, in particular, they allow the circuit to be allocated to a specific Safety Integrity Level (SIL). Data about the reliability of the field device is required particularly in the case of field devices in the form of quick-acting gate valves, which are used to vent and/or block a line in the safety position when signaling takes place to move to a safety position, which is done by disconnection of the power supply, in particular via two wire loop.

Various solution-based approaches have been adopted in the prior art in order to overcome the described problems, but these are not satisfactory. For example, it is known from the Product Bulletin from the Emerson Company for a four-wire loop to be used for a “DVC 6000” digital safety valve control device in order to ensure the pick up of data that is required particularly for functional checking of the field device, even in the event of a malfunction, and activation of the safety valve. However, a four wire loop such as this results in enormously increased wiring complexity and thus leads to the complexity of the control loop being increased, and hence to increased manufacturing and maintenance costs.

Furthermore, German Patent Document No. DE 199 29 804 A1 discloses a control system having central and/or decentralized assemblies in which protective devices such as sensors and/or actuators are connected. The assemblies are connected to one another in order to transmit data and information via at least one communication link and to supply them with at least one supply voltage via at least one power supply line, with the intention particularly being for these two lines to be in the form of a common line.

In order to ensure that the control system remains serviceable even in the event of a disturbance in the communication link and/or power supply line, one unit is in each case provided for monitoring the supply voltage and/or one unit for monitoring the communication link. As soon as a disturbance occurs, provision is made in particular for a non-material communication link to be set up between the assemblies via a transmitting/receiving unit. A dedicated standby power supply in the form of a battery is provided for the power supply.

However, this control system has the disadvantage that the large amount of energy consumed by these elements means that the high-energy standby power supply must be provided in order to maintain the operability of the control system even in the event of a malfunction. The control system thus cannot be used, in particular, in potentially explosive areas and, furthermore, a concept such as this is not consistent with the desire for lack of maintenance of the field device, owing to the need to replace the battery. Furthermore, the provision of the non-material communication link is associated with high costs, since each individual assembly must be equipped with an individual transmitting/receiving unit.

Furthermore German Patent Document No. DE 199 37 515 A1 discloses a method and an arrangement for selective recording of messages. This document proposes that a device which is arranged in a field area be temporarily connected to a monitoring device via a communication interface for monitoring purposes. During operation, messages are generated for events and states which can be determined in advance, are sent to the monitoring device, and are continuously stored in the monitoring device. When a disturbance occurs in the device to be monitored, a predefined fault signal is generated, in response to which the recording of messages is irrevocably terminated.

However, this arrangement has the disadvantage that an additional device must be manually fitted to the device to be monitored, thus involving a very high degree of complexity in order to monitor a large number of field devices within a field area. Furthermore, the arrangement in German Patent Document No. DE 199 37 515 A1 also does not allow the device to be monitored in a time period after the occurrence of a fault, in order particularly to monitor the reliability of the device to be monitored.

European Patent Document No. EP 1 161 636 B1 discloses an emergency disconnection system in which a control device controls a shut-off valve in response to a fault signal such that the shut-off valve is moved from a completely open position to a partially open position, and is moved back to the completely open position again.

### SUMMARY

The object of the present invention is to provide a functional test apparatus for a field device which can overcome the disadvantages of the prior art, and which in particular is intended to have a physically simple design and to allow reliability analyses of the functional operation of two or more field devices at low cost following the failure of the entire power supply.

This object is achieved by an apparatus that checks whether a field device, particularly a quick-acting gate valve for an emergency system, preferably of a chemical installation, of a gas burner or the like, is changed to a predetermined operating mode in the event of a power failure; by way of example, in the case of a quick-acting gate valve, to determine whether the latter is closed. This automatic adoption of the specific operating position of the field device can be provided via a spring or the like, which does not release its potential energy unless a deliberate power failure occurs.

The functional test apparatus has at least one device for detection of operating data for the field device, and at least one non-volatile memory for saving the detected operating data. At least one electrical energy buffer is provided, which acts on the device for detection of operating data and on the non-volatile memory in supplying them with power, such that the operating data of the field device is detected and is saved in a non-volatile manner at least while the field device is making a transition to the specific operating mode.

Various embodiments of the invention permit a functional test the field device independently of the power supply without significantly increasing the costs of the field device arrangement comprising the field device and the functional test apparatus. Reliability studies can thus be carried out on field devices, for example, in accordance with IEC Standard 61508/61511, with very accurate probabilities being determined for correct operation of a specific field device type, and with little measurement and design complexity.

In this case, it is possible in particular to provide for the capability to connect the functional test apparatus and the field device to the electrical power supply via a two-wire loop which can be connected, in particular, to a process control device.

An embodiment of the invention also provides that the device for detection of operating data has at least one sensor, preferably a voltage, a current level, a temperature, a movement, a pressure sensor and/or a sensor for detection of the flow rate of a fluid.

Advantageously, the electrical energy buffer can be designed for use in a potentially explosive area.

The electrical energy buffer may be based on an essentially purely physical, in particular, capacitive, operating principle, and, in particular, may be free of electrochemical, galvanic and/or electrolytic components.

In one preferred embodiment, the electrical energy buffer has an essentially rectangular energy emission characteristic. In particular, the electrical energy buffer can be designed to produce power values in a range from approximately 10 μA at approximately 0.7 V to approximately 4 mA at approximately 10 V for approximately 0.5 to 10 seconds, with an generally constant power output, preferably between 0.8 to 1 mA at between 3 to 5 V for approximately 3 to 5 seconds.

In a further embodiment of the functional test apparatus, the electrical energy buffer provides electrical power for a correctly operating field device until the specific operating mode of the field device is reached, in particular until a predetermined operating state of the field device is detected or for several seconds, preferably up to at most 10 seconds, after reaching the specific operating mode of the field device.

One particularly advantageous embodiment of the invention provides for the electrical energy buffer to have at least one supercap capacitor, preferably a gold cap capacitor. In particular, in the case of an energy buffer such as this, this buffer is followed by a step-down regulator which, in particular, allows the initial peak voltage to be stepped down, with most of the stored electrical energy being used.

It is also possible to provide for the electrical energy buffer to be chargeable particularly by the electrical power supply.

In one preferred embodiment of the invention, the electrical energy buffer is, in particular, electrically decoupled with respect to operation of the field device, and in particular is designed to produce energy in an uninfluencing manner for operation of the field device when there is no power supply.

A functional test apparatus according to an embodiment of the invention provides at least one monitoring device for detection of a fault in the electrical power supply, preferably formed by the device for detection of operating data.

An embodiment of the invention furthermore provides at least one data processing apparatus which processes data that is detected by the device for detection of operating data.

In the last-mentioned embodiment, it is possible to provide for the data processing apparatus to comprise at least one microcomputer whose clock frequency can preferably be reduced in the safety operating mode.

A functional test apparatus according to an embodiment of the invention is advantageously stores the operating data of the field device in a compressed form in at least one volatile memory, in particular via the data processing apparatus, preferably as a data record which comprises at least one operating value, such as a set value, which is transmitted to the field device, in particular via the two-wire loop, at least one actual value, such as an actuator position, of the field device, at least one measured value which is picked up via the device for detection of the operating data of the field device, such as a voltage, a current level, a pressure, a temperature, a path length, a speed, an acceleration value and/or a flow rate value of a fluid, at least one operating hours counter value and/or a device status information, and at least one time information value.

In this case, it is possible to particularly provide for the volatile memory to be a first-in-first-out (FIFO) memory.

In the case of the two embodiments mentioned above, the volatile memory may have at least one first memory area and at least one second memory area, in which case the operating data for a first time period can be stored in the first memory area and, if the first memory area overflows, the operating data from the first memory area can be stored in the second memory area, preferably in compressed form and/or using a first-in-first-out method.

It is also possible to provide at least one internal clock, particularly in the form of a real time clock, of a radio controlled clock module and/or of a relative timer, which can preferably be synchronized via a real time clock, which is comprised particularly by the process control device, and/or via a radio controlled clock module, which is preferably comprised by the process control device, in which case the time information value can be determined via the internal clock.

Advantageous embodiments of the functional test apparatus include that in the safety operating mode, the field device can be switched to a previously defined safety state and, in particular after reaching the safety state, the data which is stored in the volatile memory can be transferred to the non-volatile memory.

In one further embodiment of the invention, a potential energy device acts on the field device such that, when there is a power supply, the field device is held in a first, in particular deactivated, operating state, and, when there is no power supply, the potential energy is released in order to change the field device to the specific operating mode. The aim is thus that emergency operation of the field device should not be controlled when there is no power supply. All that is necessary during emergency operation is to monitor and record the actually predetermined forced method of operation of the field device in order that it is possible to make a statement about the reliability of the functional mode.

It is also possible to provide that the operating data which is stored in the volatile memory and/or in the non-volatile memory can be read and/or evaluated via a data processing apparatus and/or a process control device, in particular at least one characteristic variable of the field device can be determined with respect to the response in the safety operating mode, preferably at least one mean time between failures (MTBF) one path-time diagram, a response/reaction time, a closure time and/or the accuracy of reaching a zero point position, in particular in order to carry out a fault type, fault effect and/or fault diagnosis analysis.

Finally, an embodiment of the invention may provide that the non-volatile memory comprises at least one EEPROM and/or at least one FRAM and/or that the volatile memory comprises at least one RAM.

Furthermore, an embodiment of the invention relates to a method for functional testing of a field device during the transition from a normal operating mode to a safety operating mode.

The aim is to further develop the method in comparison to the method of this generic type, in order to overcome the disadvantages and, in particular, to allow reliability analyses of the functional operation of two or more field devices at low cost in a situation where the entire power supply has failed.

The object of the invention is also achieved by a method for testing of the operation of a field device, which is carried out particularly in accordance with the method of operation of the functional test apparatus described above, with the field device being operated via an electrical main power supply, and being changed to a specific operating mode when there is no electrical main power supply, in which operating data of the field device is determined and is saved in a non-volatile manner at least while the field device is making a transition to the specific operating mode, independently of the main power supply and in particular via an electrical energy buffer.

This makes it particularly possible to permit the main electrical power supply to provide electrical power via a two-wire loop, with the field device preferably being controlled and/or regulated by a process control device via the two-wire loop.

An embodiment of the invention also provides that the field device is switched to a safety state when in the safety operating mode.

In this case, the operating data may be collected in at least one volatile memory, and may be saved in at least one non-volatile memory when the safety state is reached.

In one embodiment of the method according to the invention the operating data for the field device is collected during a normal operating mode in which the supply is provided via an electrical main power supply, and/or while the field device is making a transition from the normal operating mode to the safety operating mode.

In particular, it is possible to provide for the operating data to be stored in the form of a data record comprising at least one operating value and at least one time information value.

The last-mentioned embodiment provides that at least one set value, which is transmitted to the field device, in particular via the two-wire loop, at least one actual value, such as an actuator position, of the field device, at least one measured value which is picked up via at least one sensor of the field device, such as a pressure, a temperature, a path length, a speed and/or an acceleration value, at least one operating hours counter value and/or a device status information is or are stored in particular as an operating value.

The two alternatives of the method mentioned above may include that an absolute time value is stored as the time information value, with the absolute time value preferably being determined via an internal clock, such as a real time clock and/or a radio controlled clock module, of the functional test apparatus.

In this case, the real time clock may be synchronized by a user during the normal operating mode, and/or that the functional test apparatus receives, in particular via the two-wire loop, at least one preferably digital synchronization signal, which is preferably generated by the process control device, and the real time clock may be synchronized via the synchronization signal.

As an alternative, a relative time value may be stored as the time information value, with the relative time value being determined, particularly via an internal clock, preferably in the form of a relative timer.

This permits the operating data to be recorded almost continuously during the normal operating mode and/or to be picked up in a first periodic time interval and/or the operating data to be recorded almost continuously during the safety operating mode and/or in a second periodic time interval, with the first periodic time interval preferably being longer than the second periodic time interval.

The operating data may be stored in the volatile memory using a first-in-first-out method, in which the oldest data is in each case overwritten by the respectively up-to-date data when the memory overflow occurs.

The operating data in the volatile memory may be stored in at least one first memory area and in at least one second memory area, with the operating data for a first time period being stored in the first memory area, preferably without being compressed, and, if the first memory area overflows, the operating data being read from the first memory area and being stored in the second memory area in compressed form.

In this case, it is possible to provide for the operating data to be compressed by time averaging, data reduction, preferably via a software-based algorithm, and/or the formation of histograms.

In the case of the two alternatives mentioned above, only the operating data for the first time period is stored in the second memory area.

Alternatively, the operating data for a second time period, which is longer than the first time period, can be stored in the second memory area, with the operating data preferably being stored in the second memory area using a first-in-first-out method, in which the oldest data is in each case overwritten by the respectively up-to-date data when the second memory area overflows.

In an embodiment of the invention, the operating data which is stored in the non-volatile memory and/or in the volatile memory is called up by the process control device in the normal operating mode and is transmitted to the process control device, and/or the operating data which is stored in the volatile memory and/or in the non-volatile memory is evaluated via the functional test apparatus in the normal operating mode, with the evaluation results being transmitted to the process control device, preferably via the two-wire loop.

In this case, an advantageous call up and/or evaluation of the operating data which is stored in the non-volatile memory may take place almost immediately after the field device changes from the safety operating mode to the normal operating mode, with the stored operating data being sent to the process control device, and/or the stored operating data being evaluated via the functional test apparatus, and the evaluation data being sent to the process control device.

Relative time information values of the stored operating data may be converted to absolute time information values, preferably via a comparison of the operating data with data which is stored in the process control device and relates to the duration and/or the sequence of the set values transmitted to the field device.

In particular, the operating data may permit determination of at least one characteristic variable for the field device with respect to the response in the normal operating mode and/or in the safety operating mode, preferably at least one mean time between failures (MTBF), a path-time diagram, a response/reaction time, a closure time and/or the accuracy of reaching a zero point position, in particular in order to carry out a fault type, a fault effect and/or a fault diagnosis analysis.

Finally, the method can provide for the power consumption of the functional test apparatus to be reduced in the specific operating mode, preferably by switching off functions which are not required, such as the operation of an actuator, and/or by reduction of the clock frequency of a microcomputer.

Furthermore, a field device is provided, in particular a quick-acting gate valve, comprising at least one functional monitoring apparatus according to various embodiments of the invention, which field device is operated particularly on the basis of a method according to various embodiments of the invention.

The novel aspects described above are based in part on the surprising discovery that it is possible to use various above-described embodiments of the functional test apparatus and appertaining methods, without significantly increasing the physical complexity of a field device, to monitor such a field device in such a way that it complies even with the most stringent safety requirements.

Thus, despite the fact that little power is available, typically 20 to 40 mW, and the limited number of possible cycles for writing to a non-volatile memory, operating data can be recorded and analyzed generally without any gaps in the time period before disconnection of a power supply, in particular via a two-wire loop, as well as in the period between disconnection and the point at which a safety state is reached in a safety operating mode by using a local electrical supply, in the form of an electrical energy buffer, to ensure that power is supplied during the safe operating mode.

First of all, during a normal operating mode, important data, particularly set values, actual values of position regulators, measurement variables for sensors as well as states of operating state counters and data relating to the internal device status is advantageously recorded continuously in a separate data area within the preferably microcomputer-based field device, by first of all storing this operating data in a volatile memory.

Owing to the restriction in the memory volume of two-wire devices, a ring buffer may advantageously be used, which stores the operating data for a limited time period, but continuously updates this time period. In this case, provision is advantageously made particularly for additional data compression of the operating data to be carried out for a second, longer time period, for example in the form of histograms.

After an interruption or disconnection of the power supply via the two-wire loop, i.e., during the safety operating mode, the power supply for the functional test apparatus is briefly drawn from the electrical energy buffer. During this time, the field device is, in particular, changed to a safety state, with the functional test apparatus still picking up operating data for the field device in the volatile memory, and with the operating data being saved in a non-volatile manner, and thus permanently, together with the operating data picked up during the normal operating mode, in particular on reaching the safety state.

The valve transit time (i.e., the time to move from an open position to a closed position) is measured particularly in the safety operating mode after disconnection of the power supply, and these determined values are thus permanently stored.

When a process installation which includes the field device is switched on again after a safety disconnection, the field device changes back from the safety operating mode to the normal operating mode, with a power supply being ensured via the two-wire loop, and the data stored in the non-volatile memory can either be evaluated directly in the normal manner in the functional test apparatus, with the evaluation data being sent via communication via the two-wire loop to the process control device and/or the data stored in the non-volatile memory can be called up and analyzed by the process control device.

In particular, the picked up operating data makes it possible to draw conclusions about the reliability of the field device. Particularly in the case of quick-acting gate valves, such monitoring is enormously important since, in fact, these quick-acting gate valves ensure that no critical states occur within the process installation when a safety disconnection occurs.

The storage of operating data without hardly any gaps is made possible particularly because the number of elements to be supplied with electrical power within the functional test apparatus during a safety operating mode is small, and their power consumption is low. Thus, in particular, only one data processing apparatus, which is included in the functional test apparatus, and is preferably in the form of a microcomputer, the volatile memory, in particular in the form of a RAM, the non-volatile or permanent memory, for example in the form of an EEPROM or FRAM, and a sensor, for example a movement sensor, in particular of a position controller, need to be supplied with power.

Only a small amount of energy is therefore required from the electrical energy buffer in order to briefly ensure the electrical supply when a safety disconnection occurs, i.e., when the power supply is disconnected via the two-wire loop, in order to allow the picking-up and non-volatile saving of the operating data. By way of example, the time for a quick-acting gate valve to operate is a few seconds, so that the electrical supply for the functional test apparatus need be ensured only for this time from the electrical energy buffer during a safety disconnection of the valve.

These constraints allow the use of electrical energy buffers which comply with stringent safety requirements, in particular allowing use in Zone 1 and 2 potentially explosive areas.

As described herein, an electrical energy buffer is, in particular, an energy storage which can store electrical energy and can emit it as required. Furthermore, an electrical energy buffer is also an apparatus which can store energy, particularly in the field device, which is in a form other than an electrical form, in particular kinetic energy, and can produce and emit electrical energy from this energy as required.

In particular, the constraints allow the use of energy storages which are based on primarily purely physical storage of energy and do not require electrochemical or electrolytic components. For use in a potentially explosive area, it is particularly important that incorrect polarity, in particular a short circuit, of the energy storage does not lead to heat being developed and to vaporation of parts of the energy storage, as is the case with energy storages, such as batteries or rechargeable batteries, which have electrochemical or electrolytic components.

Ionic solutions occur in particular in electrolytic or electrochemical components, which can vaporize when overheated and can lead to the energy storage exploding. Thus, by way of example, supercap capacitors, in particular gold cap capacitors, can be used in the functional test apparatus, in which a dielectric is formed by an H₂O layer which is adsorbed on a noble metal sheet.

These energy storages, which are based on a physical storage principle, have an adequate amount of energy to supply the functional test apparatus during the safety operating mode, with a small physical size and low susceptibility to defects, and with the freedom from maintenance resulting from this. Suitable connection of the energy storage in the form of such a capacitor allows the discharge curve of the energy storage, which is inversely proportional to the time, to be matched to the energy requirements of the functional test apparatus, and precludes excessive heat development in the event of a short circuit.

This form of electrical energy buffer ensures that sufficient energy is provided in order to make it possible to transmit the data in the volatile memory to the non-volatile memory. This leads to the advantage that the operating data can be made available later, and can be analyzed, for the entire time period before the occurrence of the safety disconnection, by virtue of the storage in the non-volatile memory. This further reduces the number of write cycles required to the non-volatile memory, since only one write cycle is applied to it when the power supply is disconnected. This leads to a further increase in the freedom of maintenance of the field device, since the non-volatile memory need not be replaced until after longer operating times.

### DESCRIPTION OF THE DRAWINGS

Further features and advantages of the invention will become evident from the following description, in which various embodiments of the invention are explained by way of example with reference to the following figures.

FIG. 1 is a block circuit diagram showing an arrangement according to an embodiment of the invention comprising a field device and a functional test apparatus; and

FIG. 2 is a time graph of the functional operation of the field device when the power supply for the field device is interrupted.

### DETAILED DESCRIPTION OF THE PREFERRED EMBODIMENTS

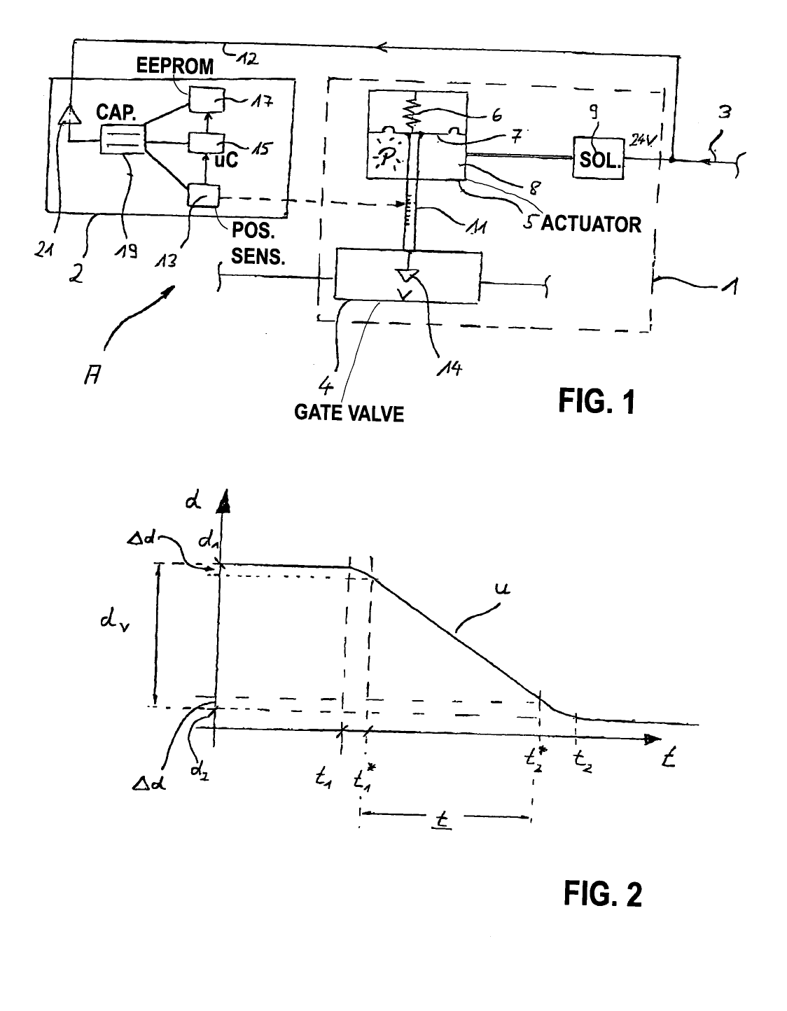

FIG. 1 shows a high-level schematic block diagram of a field device arrangement A with a field device 1 and a functional test apparatus 2, according to an embodiment of the invention.

The field device 1 and the functional test apparatus 2 are connected via a two-wire loop 3 to a process control device, which is not illustrated, and to a main power supply, which is not illustrated.

The field device 1 has a quick-acting gate valve 4, which is operatively connected to an actuator 5 such that the quick-acting gate valve 4 is open in a deactivated state, as illustrated in FIG. 1, and is completely closed in an activated state, which is not illustrated in FIG. 1.

The actuator 5 has a spring 6 which is prestressed in the deactivated state and presses against a membrane 7, which partially limits a pressure chamber 8. In the deactivated state, there is an increased pressure p in the pressure chamber 8, which is maintained via a 24 V solenoid valve 9. The pressure is increased to such an extent that the spring 6 is moved to the prestressed state by the membrane 7. One end of an actuator rod 11 is arranged on the opposite side of the active surface of the spring 6 on the membrane 7.

If power is no longer fed to the 24 V solenoid valve 9, for example during a power failure that has been initiated, the pressure chamber 8 is vented, thus releasing the potential energy from the spring 6 and moving the actuator rod 11, with a valve closure 14 located at the end, to the closed position.

The functional operation of a correctly operating field device 1 is illustrated in FIG. 2 on the basis of a path-time diagram. When the quick-acting gate valve 4 is in the deactivated state, the valve closure is in the movement position d₁, which is at a distance dᵥ from the end position d₂. A power failure is initiated for test purposes at the time t₁. After a response time t*₁, which can be determined by the time (t₁−t*₁) required to reduce the distance dᵥ by Δd (approximately 1% of dᵥ), a transitional phase u of the quick-acting gate valve 4 starts from the deactivated position to the activated closed position, which is reached when the valve closure is at least Δd (approximately 1% of dᵥ) away from the end position d₂.

The functional test apparatus 2 checks functional parameters of the field device: the closing time t, which is defined by the time interval between t*₁ and t*₂; the response time, the continuity of the transitional phase u; etc.

The functional test apparatus 2 is electrically connected to the two-wire loop 3 via a line 12. The functional test apparatus 2 has a device for detection of operating data for the field device 1, to be more precise, for the determination of the position of the quick-acting gate valve 4, in the form of a movement sensor 13, which is operatively connected to the actuator rod 11 for the quick-acting gate valve 4.

Furthermore, the functional test apparatus 2 has a data processing apparatus in the form of a microcomputer 15, which is connected to the movement sensor 13, and a volatile memory (which is not illustrated) in the form of a RAM, as well as a non-volatile memory 17 in the form of an EEPROM, which are operatively connected to one another and to the microcomputer 15. Furthermore, the functional test apparatus 2 has a local power supply or an electrical energy buffer in the form of a gold cap capacitor 19.

The 24 volt solenoid valve and the movement sensor may preferably be combined in one component, as a position controller. Finally, the functional test apparatus 2 has a diode 21, which is designed to prevent energy flowing back from the capacitor 19, in particular via the lines 12 and 3, to the 24 volt solenoid valve.

The procedure in a method according to an embodiment of the invention and the method of operation of the functional test apparatus according to an embodiment of the invention will now be described with reference to FIG. 1. When an intact power supply is provided via the two-wire loop 3, the field device 1 is in a normal operating mode. In particular, the individual components are supplied with power via the two-wire loop 3 and, furthermore, digital signals are transmitted to the microcomputer 9 via the two-wire loop 3.

Different signals which are supplied via the two-wire loop 3 to the actuator 5 make it possible to control the actuator 5 in order to move the position of the quick-acting gate valve. The position of the valve is determined via the movement sensor 13. The measurement data from the movement sensor 13 is further processed by the microcomputer 15. The microcomputer 15 receives time information data via a real time clock (not illustrated). This data record, comprising the movement sensor data and the time information data, is initially stored in the RAM.

The RAM may be in the form of a ring buffer, which operates by way of the first-in-first-out (FIFO) principle. This means that the data is stored in the RAM in such a way that, in the event of a memory overflow in the RAM, the oldest data is overwritten with the newest data. The measurement data from the movement sensor 13 is recorded at fixed time intervals, for example, once per second, and is stored in the RAM. This means that the movement sensor data is always stored for a fixed time period in the RAM.

In one embodiment, which is not illustrated, it is possible to provide for the RAM to comprise different memory areas. In this embodiment, the data is stored in a first memory area in a first time resolution, for example, once per second. If the first memory area overflows, then the data is read from the first memory area, is compressed by the microcomputer 15 by averaging the measurement data over a predetermined time period, and is then stored in a subsequent second memory area, so that the measurement data is stored with a lower resolution, for example, once every three or five seconds, in this subsequent second memory area.

Furthermore, a chain of further memory areas may also be provided in which the data from a previous memory area, in particular the second memory area, is compressed further in a similar manner when the previous memory area overflows, and is stored in a subsequent memory area with an even coarser time resolution.

It is also possible to provide for the data records not to comprise absolute time information but only relative time information by using a relative timer instead of the real time clock. During subsequent analysis of the data, absolute time values can be calculated from these relative time values by comparison with control signals, which are applied to the field device 1 via the two-wire loop 3, or by signals transmitted from the field device to the process control device, in particular via the two-wire loop.

If the power supply is now disconnected via the two-wire loop 3, then such an interruption can first of all be detected by a monitoring device, which is not illustrated, and the functional test apparatus 2 can be switched to a safety operating mode. The movement sensor 13, the microcomputer 15, the RAM, the real time clock and the EEPROM 17 are supplied with power via the capacitor 17 in this safety operating mode.

While the quick-acting gate valve 4 is moving to the activated safety operating mode, movement data for the quick-acting gate valve 4 is picked up via the movement sensor 13 with a high time resolution, and is stored in the RAM together with the time information values. When the quick-acting gate valve 4 reaches its safety position, then the data is read from the RAM, and is stored in the EEPROM 17.

In order to make it possible to use the restricted amount of energy that is stored in the capacitor 19 effectively, provision is made particularly for the clock frequency of the microcomputer 9 to be reduced, in order to further reduce the power consumption of the active elements.

Since the EEPROM 17 is a non-volatile memory, this ensures that the picked up operating data, which was previously stored in the RAM, is not lost even once all of the energy in the capacitor 19 has been mostly consumed, but that the data can be read from the EEPROM 17 and analyzed once the power supply has been restored via the two-wire loop 3. The operating data which is stored in the EEPROM 17 in particular allows detailed analysis of the behavior of the field device shortly before the disconnection of the power supply via the two-wire loop 3, during the disconnection and after the disconnection has occurred, particlularly while the valve is moving to a safety position.

This picked up operating data makes it possible to deduce the reliability of the field device, so that the field device can be classified in a higher safety level, since this ensures that a threatened malfunction of the field device is identified at an early stage on the basis of the comprehensive available data.

The features of the invention as disclosed in the above description, in the drawings and in the claims may be utilized for to the implementation of the various embodiments of the invention both individually and in any desired combination.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### LIST OF REFERENCE SYMBOLS

1 Field device
2 Functional monitoring apparatus
3 Two-wire loop
4 Quick-acting gate valve
5 Actuator
6 Spring
7 Membrane
8 Pressure chamber
9 24 volt solenoid valve microcomputer
11 Actuating rod
13 Position sensor
14 Valve closure
15 Microcomputer
17 EEPROM
19 Capacitor
21 Diode
A Field device arrangement
u Transitional phase
p Overpressure.

1. A functional test apparatus for a field device with the field device configured to change or to be changed to a specific operating mode in case there is no power supply, comprising:
at least one device configured to detect operating data for the field device;
at least one non-volatile memory configured to save the detected operating data;
at least one electrical energy buffer configured to act on the device for detection of operating data and on the non-volatile memory for supplying them with power, such that the operating data of the field device is detected and is saved in a non-volatile manner at least while the field device is making a transition to the specific operating mode.

2. The functional test apparatus as claimed in claim 52, wherein the emergency system is comprised by an installation of a chemical installation or a gas burner.

3. The functional test apparatus as claimed in claim 1, wherein the functional test apparatus and the field device are configured to be connected to the electrical power supply via a two-wire loop.

4. The functional test apparatus as claimed in claim 1, wherein the device for detection of operating data comprises at least one sensor.

5. The functional test apparatus as claimed in claim 4, wherein the sensor is selected from the group consisting of a voltage measuring device, a current level measuring device, a temperature sensor, a movement sensor, a pressure sensor and a sensor for detection of the flow rate of a fluid.

6. The functional test apparatus as claimed in claim 1, wherein the electrical energy buffer is configured for use in a potentially explosive area.

7. The functional test apparatus as claimed in claim 1, wherein the electrical energy buffer is based on an essentially purely physical operating principle.

8. The functional test apparatus as claimed in claim 7, wherein the electrical energy buffer comprises a capacitor.

9. The functional test apparatus as claimed in claim 8, wherein the capacitor is at least one supercap capacitor.

10. The functional test apparatus as claimed in claim 9, wherein the supercap capacitor is a gold cap capacitor.

11. The functional test apparatus as claimed in claim 1, wherein the electrical energy buffer has an essentially rectangular or stepwise energy emission characteristic.

12. The functional test apparatus as claimed in claim 11, wherein the electrical energy buffer is configured to produce power values in a range from approximately 10 μA at approximately 0.7 V to approximately 4 mA at approximately 10 V for approximately 0.5 to 10 seconds, with an essentially constant power output.

13. The functional test apparatus as claimed in claim 12, wherein the electrical energy buffer is configured to produce power values in a range from approximately 0.8 mA at approximately 3 V to approximately 1 mA at approximately 5 V for approximately 3 to 5 seconds, with an essentially constant power output.

14. The functional test apparatus as claimed in claim 1, wherein the electrical energy buffer is configured to provide electrical power for a correctly operating field device until the specific operating mode of the field device is reached, or for less than or equal to approximately 10 seconds after reaching the specific operating mode of the field device.

15. The functional test apparatus as claimed claim 1, wherein the electrical energy buffer is configured to be charged.

16. The functional test apparatus as claimed in claim 1, wherein the electrical energy buffer is decoupled with respect to operation of the field device.

17. The functional test apparatus as claimed in claim 1, further comprising at least one data processor that is configured to processes data which is detected by the device for detection of operating data.

18. The functional test apparatus as claimed in claim 1, wherein the data processor comprises at least one microcomputer whose clock frequency is configured to be reduced in the specific operating mode.

19. The functional test apparatus as claimed in claim 1, further comprising:
at least one volatile memory in which the operating data of the field device is stored in a compressed form.

20. The functional test apparatus as claimed in claim 19, wherein the stored operating data comprises a data record comprising:
at least one operating value that is transmitted to the field device, at least one actual value of the field device, at least one measured value which is picked up via the device for detection of the operating data of the field device, at least one operating time counter value or a device status information, and at least one time information value.

21. The functional apparatus as claimed in claim 20, wherein:
the operating value is a set value;
the actual value is an actuator position; and
the measured value is at least one of a voltage, current level, pressure, temperature, path length, speed, acceleration value and flow rate value of a fluid.

22. The functional test apparatus as claimed in claim 19, further comprising:
at least one internal clock.

23. The functional test apparatus as claimed in claim 68, wherein at least one of the synchronizing real time clock is comprised by the process control device, or the synchronizing radio controlled clock module is comprised by the process control device.

24. The functional test apparatus as claimed in claim 1, further comprising a potential energy device configured to act on the field device such that, when there is a power supply, the field device is held in a first operating state, and, when there is no power supply, the potential energy is released in order to change the field device to the specific operating mode.

25. The functional test apparatus as claimed in claim 1, further comprising a data processor or a process control device configured to read or evaluate the operating data which is stored in a volatile memory or in the non-volatile memory.

26. A method for testing an operation of a field device with a functional test apparatus, comprising:
operating the field device via an electrical main power supply;
changing the field device from a normal operating mode to a specific operating mode when there is no electrical main power supply;
determining and saving operating data of the field device in a non-volatile manner at least while the field device is making a transition to the specific operating mode independently of the main power supply and via an electrical energy buffer.

27. The method as claimed in claim 54, wherein the emergency system is comprised by an installation of a chemical installation or a gas burner.

28. The method as claimed in claim 26, further comprising:
collecting the operating data in at least one volatile memory; and
saving the operating data in at least one non-volatile memory when there is no power supply.

29. The method as claimed in claim 26, further comprising:
saving the operating data for the field device in a non-volatile manner during a normal operating mode in which the supply is provided via an electrical main power supply, and while the field device is making a transition from the normal operating mode to the specific operating mode.

30. The method as claimed in claim 26, further comprising:
storing the operating data as a data record comprising at least one operating value and at least one time information value, in which case at least one set value, which is transmitted to the field device, at least one actual value of the field device, at least one measured value which is picked up via at least one sensor of the field device, at least one operating time counter value or a device status information is or are stored.

31. The method as claimed in claim 30, wherein:
the actual value is an actuator position of the field device; and
the measured value is at least one of a pressure, temperature, path length, speed, acceleration value.

32. The method as claimed in claim 30, further comprising:
storing an absolute time value as the time information value.

33. The method as claimed in claim 32, further comprising:
determining the absolute time value via an internal clock that is a real time clock or a radio controlled clock module.

34. The method as claimed in claim 32, further comprising:
synchronizing the real time clock by a user during the normal operating mode; or
synchronizing the real time clock utilizing at least one synchronization signal generated by the process control device that is received.

35. The method as claimed in claim 30, further comprising:
storing a relative time value as the time information value.

36. The method as claimed in claim 75, wherein the internal clock is a relative timer.

37. The method as claimed in claim 26, further comprising:
a1) recording the operating data nearly continuously during the normal operating mode; or
b1) picking up the operating data in a first periodic time interval; and
a2) recording the operating data nearly continuously during the specific operating mode; or
b2) picking up the operating data in a second periodic time interval.

38. The method as claimed in claim 37, wherein the first periodic time interval is longer than the second periodic time interval.

39. The method as claimed in claim 37, wherein only the operating data for a first time period is stored in a second memory area.

40. The method as claimed in claim 37, further comprising:
storing the operating data for a second time period, which is longer than the first time period, in a second memory area.

41. The method as claimed in claim 40, wherein the operating data is stored in the second memory area using a first-in-first-out method, in which the oldest data is in each case overwritten by the respectively up-to-date data when the second memory area overflows.

42. The method as claimed in claim 26, further comprising:
compressing the operating data by time averaging, data reduction, or the formation of histograms.

43. The method as claimed in claim 42, wherein the data reduction is performed via a software-based algorithm.

44. The method as claimed in claim 26, further comprising:
a1) calling up the operating data which is stored in non-volatile memory or in volatile memory by the process control device in a normal operating mode; and
a2) transmitting the called up operating data to a process control device; or
b1) evaluating the operating data which is stored in volatile memory or in non-volatile memory via the functional test apparatus in the normal operating mode; and
b2) transmitting the evaluation results to the process control device.

45. The method according to claim 44, wherein the transmitting of the operating data or the evaluation results occurs via a two-wire loop.

46. The method as claimed in claim 44, wherein the call up or evaluation of the operating data which is stored in the non-volatile memory takes place essentially immediately after the field device changes from the specific operating mode to the normal operating mode, with: a) the stored operating data being transmitted to the process control device, or b) the stored operating data being evaluated via the functional test apparatus and the evaluation data being transmitted to the process control device.

47. The method as claimed in claim 26, further comprising:
determining from the operating data at least one characteristic variable for the field device with respect to a response in the normal operating mode or in the specific operating mode.

48. The method as claimed in claim 47, wherein the characteristic variable is selected from the group consisting of: at least one mean time between failures (MTBF), a path-time diagram, a reaction time, a closure time, and an accuracy of reaching a zero point position.

49. The method as claimed in claim 26, further comprising:
reducing power consumption of the functional test apparatus in the specific operating mode.

50. The method as claimed in claim 49, wherein the reducing of power comprises at least one of:
switching off functions which are not required;
switching off operation of an actuator; and
reducing a microcomputer clock frequency.

51. A field device configured to change or to be changed to a specific operating mode, in case there is no power supply, comprising at least one functional test apparatus, the at least one functional test apparatus comprising:
at least one device configured to detect operating data for the field device;
at least one non-volatile memory configured to save the detected operating data;
at least one electrical energy buffer configured to act on the device for detection of operating data and on the non-volatile memory for supplying them with power, such that the operating data of the field device is detected and is saved in a non-volatile manner at least while the field device is making a transition to the specific operating mode.

52. The functional test apparatus as claimed in claim 1, wherein the field device is a quick-acting gate valve for an emergency system.

53. The functional test apparatus as claimed in claim 1, wherein the specific operating mode is a safety or an emergency operating mode.

54. The method for testing the operation of a field device as claimed in claim 26, wherein the field device is a quick-acting gate valve for an emergency system.

55. The method for testing the operation of a field device as claimed in claim 26, wherein the specific operating mode is a safety or an emergency operating mode.

56. The functional test apparatus as claimed in claim 51, wherein the field device is a quick-acting gate valve for an emergency system.

57. The functional test apparatus as claimed in claim 51, wherein the specific operating mode is a safety or an emergency operating mode.

58. The functional test apparatus as claimed in claim 3, wherein the two-wire loop is configured to be connected to a process control device.

59. The functional test apparatus as claimed in claim 7, wherein the electrical energy buffer is based on a capacitive operating principle.

60. The functional test apparatus as claimed in claim 7, wherein the electrical energy buffer is free of at least one of electrochemical, galvanic and electrolytic components.

61. The functional test apparatus as claimed in claim 14, wherein until the specific operating mode of the field device being reached is until a predetermined operating state of the field device is detected.

62. The functional test apparatus as claimed in claim 15, wherein the electrical energy buffer is configured to be charged by an electrical power supply for the field device.

63. The functional test apparatus as claimed in claim 16, wherein the decoupling is an electrical decoupling.

64. The functional test apparatus as claimed in claim 16, wherein electrical energy buffer is configured to produce energy in an uninfluencing manner for operation of the field device when there is no power supply.

65. The functional test apparatus as claimed in claim 19, wherein the operating data of the field device is stored in a compressed form via the data processor.

66. The functional test apparatus as claimed in claim 20, wherein the at least one operating value is transmitted to the filed device via a two-wire loop.

67. The functional test apparatus as claimed in claim 22, wherein the at least one internal clock is in the form of a real time clock, of a radio controlled clock module or of a relative timer.

68. The functional test apparatus as claimed in claim 22, wherein the at least one internal clock is configured to be synchronized via at least one of: a) a real time clock, and b) a radio controlled clock module in which case a time information value can be determined via the internal clock.

69. The functional test apparatus as claimed in claim 24, wherein the first operating state is a deactivated operating state.

70. The functional test apparatus as claimed in claim 25, wherein the reading, evaluating and determining is performed in order to carry out a fault type, fault effect, or fault diagnosis analysis.

71. The functional test apparatus as claimed in claim 25, wherein the operating data comprises at least one characteristic variable of the field device that is determined with respect to a response when there is no power supply and that is selected from the group consisting of at least one path-time diagram, a reaction time, a closure time and an accuracy of reaching a zero point position.

72. The method as claimed in claim 30, wherein the transmission to the field device is performed via a two-wire loop.

73. The method as claimed in claim 30, wherein the information is or are stored as an operating value.

74. The method as claimed in claim 34, wherein receipt of the synchronization signal is done via the two-wire loop.

75. The method as claimed in claim 35, wherein the relative time value is determined via an internal clock.

76. The method as claimed in claim 47, wherein the determining of the at least one characteristic variable is done in order to carry out a fault type, a fault effect and/or a fault diagnosis analysis.

77. The method as claimed in claim 34, wherein the synchronization signal is a digital synchronization signal.
